(19) United States
(12) Patent Application Publication
(10) Pub. No.: US 2014/0113516 A1
(43) Pub. Date: Apr. 24, 2014

(54) COATING MATERIAL FOR AIRBAG BASE FABRIC, AND AIRBAG BASE FABRIC

(71) Applicant: Toyota Gosei Co., Ltd, Kiyosu-shi, Aichi-ken (JP)

(72) Inventors: Koki Tanaka, Kiyosu-shi (JP); Daisuke Tsutsumi, Kiyosu-shi (JP); Hiroyuki Kobayashi, Kiyosu-shi (JP); Yuh Kimura, Kiyosu-shi (JP); Motoaki Naruse, Kiyosu-shi (JP); Masamichi Kajiro, Kiyosu-shi (JP)

(21) Appl. No.: 14/125,428

(22) PCT Filed: Sep. 27, 2012
(86) PCT No.: PCT/JP2012/074875

§ 371 Date: Dec. 11, 2013

(30) Foreign Application Priority Data
Sep. 28, 2011 (JP) 2011-211808
Mar. 28, 2012 (JP) 2012-74443
Mar. 30, 2012 (JP) 2012-80716

(51) Int. Cl. C09D 7/12; D03D 1/02; D06M 15/333; D06M 15/564; B60R 21/235; D06M 15/263

(52) U.S. Cl. CPC C09D 7/1233; B60R 21/235; D06M 15/263; D06M 15/333; D06M 15/564; D03D 1/02
USPC 442/65; 427/389.9; 427/209; 524/377; 442/85; 442/104

(57) ABSTRACT

The present invention relates to an aqueous coating material based on a water-soluble resin having the OH group for airbag base fabric. The water-soluble resin is a polyvinyl alcohol (PVAL). An aliphatic carboxylic acid or polyisocyanate which can cross-link with the OH group of the PVAL by heat treatment, and polyol as a plasticizer such as a liquid polyethylene glycol which does not volatilize in heat treatment are added. A water-insoluble coating film having excellent heat and moisture resistance (hot water resistance) and flexibility can be formed on one surface or both surfaces of the cloth.

### TECHNICAL FIELD

The present invention relates to a coating material based on a water-soluble resin for an airbag base fabric, and the airbag base fabric. Particularly, the invention relates to a coating material for an airbag base fabric which can form a coating film (coat) having excellent heat and moisture resistance (hot water resistance) and flexibility on the airbag base fabric.

Hereinafter, “parts” representing a blending unit is a mass unit unless otherwise noted.

### BACKGROUND ART

An airbag device for protecting occupants is mounted in a vehicle. For the airbag base fabric incorporated in the airbag device, a cloth composed of (for example, plain weaving) fiber yarns (for example a polyamide fiber, a polyester fiber) is used.

The purpose of the airbag is to protect occupants in a vehicle. As the basic performance, the bag should inflate in an instant and have an air shutoff property for securing a sufficient time and air pressure (Patent Document 1, Paragraph 0002, Lines 5-7).

In order to secure an appropriate airflow (air barrier property) on the airbag base fabric, one surface or both surfaces of the cloth were coated with a coat (coating film) of a silicone elastomer or a urethane elastomer (the same document, Paragraph 0003).

In addition, all of the coating materials of the coating films were emulsion coating materials (Patent Documents 2 and 3, each Abstract, etc.).

However, since preparation of the emulsion coating material is troublesome and many of the additives are expensive, the coating material is likely to relatively increase in cost.

Thus, a coat (coating film) may be formed on one surface or both surfaces of the cloth (base fabric) by using an aqueous coating material based on a water-soluble resin, for example, polyvinyl alcohol (PVAL) or the like (Patent Document 1, Examples 1-4 etc.)

In this case, the airbag requires heat and moisture resistance for exerting a coating performance under heat and humidity in a parked vehicle (see Patent Document 1, Paragraph 0002, etc.)

On the other hand, recently, cloth having a relatively-low cover factor (K) has tended to be used, because light weight, low cost and the like have been demanded for the airbag base fabric.

It should be noted that the cover factor (K) is represented by the following formula (1) (Hereinafter, the same shall apply).

K=NW×DW^{0.5}+NF×DF^{0.5} (1)

wherein, NW: warp density (thread/in), DW: warp fineness (denier),

NF: weft density (thread/in), DF: weft fineness (denier)

The excessively low or high cover factor (K) means that warp and weft densities and/or warp and weft finenesses are relatively low or high.

In the case of the cloth having a low cover factor, more heat and moisture resistance (hot water resistance) and more flexibility (extensibility) than in the past have been required for the coating film from the viewpoint of the exertion of the above-mentioned performance.

However, in a case of a water-soluble resin, improvement of the heat and moisture resistance is fundamentally limited, and furthermore, many water-soluble resins are hard and brittle. Thus, water-soluble resins have been considered to be difficult to treat as a coat material formed on the airbag base fabric.

On the other hand, since the airbag is housed in a housing and mounted in a vehicle while folded, it is desirable that the airbag is made of a base fabric which is easy to crease during folding and can minimize restoration (spring back) which undoes the folding lines after being creased and folded once.

However, it has been considered to be difficult to realize an airbag base fabric having such features in a base fabric having a coating film made of the water-soluble resin.

### CITATION LIST

### Patent Documents

Patent Document 1: JP No. 4372297 B
Patent Document 2: JP No. H7-40798 A
Patent Document 3: JP No. H8-85405 A

### DISCLOSURE OF THE INVENTION

### Problems to be Solved by the Invention

In light of the above description, the object of the present invention is to provide a coating material for an airbag base fabric based on a water-soluble resin which can form a water-insoluble coating film (coat) having excellent heat and moisture resistance (hot water resistance) and flexibility on one surface or both surfaces of the cloth.

Another object of the present invention is to provide an airbag base fabric which is easy to crease during folding in mounting it in a vehicle and can reduce restoration which eliminates the folding lines after folding.

### Means for Solving the Problems

The coating material for the airbag base fabric of the present invention solves the above problems (objects) by the following constitution.

The aqueous coating material based on the water-soluble resin for the airbag base fabric is characterized in that

the water-soluble resin is polyvinyl alcohol (PVAL), and

an aliphatic polycarboxylic acid or polyisocyanate which can react with the OH group of the PVAL as a cross-linker, and a liquid polyol as a plasticizer are added.

The present invention can be expressed below as a superordinate concept.

The aqueous coating material based on the water-soluble resin for the airbag base fabric is characterized in that

the water-soluble resin contains the OH group as a water-solubilizing group, and

an organic cross-linker which has a functional group (reactive group) which can form a cross-linked coating film by reacting with the OH group and can provide a required heat and moisture resistance to the cross-linked coating film, and a plasticizer having a plurality of OH groups are added.

The airbag base fabric of the present invention solves the above problems using the following constitution.

The airbag base fabric constructed by forming a coating film through application of a coating material on a surface of a cloth composed of a textile is characterized in that

it comprises the cloth made of a polyester fiber and having a cover factor (K)=NW×DW^{0.5}+NF×DF^{0.5} (Wherein NW: warp density (thread/in), DW: warp fineness (denier), NF: weft density (thread/in), DF: weft fineness (denier)) set within 1200-2400 and the coating film having a Young's modulus set to be smaller than of the cloth, and

the airbag base fabric shows an airflow of 0.3 L/(min·cm²) or less at 20 KPa, and a height of a test specimen after <Spring back test> on the following conditions ranges within 15-35 mm.

<Spring Back Test>

1) A band-like test specimen of 150 mm×30 mm is prepared by cutting from the airbag base fabric so that the longitudinal direction is parallel to the warp or the weft.

2) The test specimen is folded up four times while the width of the longitudinal side is shortened.

3) The folded test specimen is laid on a horizontal plane, on which a 3000 g weight having a 50-square mm bottom surface is put and pushed for 60 seconds.

4) The test specimen after the weight is removed is left on the horizontal plane with both ends of the longitudinal direction upward for 2 minutes, and then the height of the test specimen is measured.

### BRIEF DESCRIPTION OF THE DRAWINGS

FIG. 1 represents graphs showing the test results of each item in Elution rate (A) and Degree of swelling (B) in the hot water resistance test of the coating films (film) formed by each aqueous coating material having a different cross-linker in the PVAL-crosslinker system.

FIG. 2 represents a graph showing the test results of each item in Elution rate and Degree of swelling in a hot water resistance test of the coating films formed by each aqueous coating material having a different citric acid content in the PVAL-citric acid system.

FIG. 3 represents a graph showing the results of bending resistance measurement by bending resistance method B for the coating film formed by each aqueous coating material having a constant citric acid content in the PVAL-citric acid system (20 parts of citric acid to 100 parts of PVAL) and having a different polyethyleneglycol (PEG) content.

FIG. 4 represents a graph showing compounding ratios of citric acid in the composition of 60 phr of PEG and time-course elongation percentages (EB) of the coating film in heat aging test for the coating film.

FIG. 5 represents a graph showing the test results of the degree of swelling in the hot water resistance test of the coating films formed by each aqueous coating material having a different citric acid content in the PVAL-citric acid-plasticizer system.

FIG. 6 represents a graph showing a relationship between the heating treatment time for hardening the coating film and the degree of swelling (ΔW) of the PVLA single-layered coating film.

FIG. 7 represents a graph showing the time-course degree of swelling in heat aging test for the coating film in various combinations of the compounding ratios of PEG and citric acid.

FIG. 8 represents a graph showing initial dynamic viscoelasticities (E′) of each coating film having a changed amount of PEG at −50° C. to 80° C.

FIG. 9 represents a schematic view illustrating the method for testing the spring back of the airbag base fabric.

FIG. 10 represents a schematic cross-sectional view of an airbag device for a steering wheel which is an example of an airbag device using the airbag base fabric in Embodiments.

FIG. 11 represents a schematic view illustrating folding steps of the airbag used for the airbag device in FIG. 10.

### BEST MODE FOR CARRYING OUT THE INVENTION

Hereinafter, the coating material for the airbag base fabric of the present invention will be developed and explained on the basis of the invention expressed by the superordinate concept.

(A) Coating Material of the First Embodiment:

The coating material of the embodiment is based on a water-soluble resin and based on the premise that the water-soluble resin comprises OH as a water-solubilizing group.

The water-soluble resin may include PVAL, carboxymethylcellulose, etc.

Above all, PVAL is preferable. More specifically, PVAL having a saponification degree of 70 mol % or higher and a polymerization degree of 1000-4000, preferably the saponification degree of 80-95 mol % and the polymerization degree of 1500-3800 is preferable. If the saponification degree is too low, a required heat and moisture resistance is difficult to secure for the cross-linked coating film. On the other hand, if the saponification degree is too high, crystallinity is high and thus a required flexibility is difficult to obtain for the cross-linked coating film. In addition, if the polymerization degree is too low, a required strength is difficult to obtain, on the other hand, if the polymerization degree is too high, the viscosity of the coating material is likely to considerably increase, resulting in problems in handling.

More specifically, PVAL may include “JP-33” (Saponification degree: 86.5-89.5%, Viscosity: 70-802 mPa·s), “JP-24” (Saponification degree: 87.0-89.0%, Viscosity: 40-502 mPa·s), “JP-18” (Saponification degree: 87.0-89.0%, Viscosity: 23-272 mPa·s), etc., marketed from JAPAN VAM & POVAL CO., LTD. It should be noted that the viscosity is under “4%, 20° C.”.

(1) To the water-soluble resin, an organic cross-linker having a functional group (reactive group) which can form a cross-linked coating film by reaction with OH groups is added. Because the heat and moisture resistance is improved by cross-linking the coating film.

The functional group which can cross-link with the OH group may include the carboxyl group (COOH), the isocyanate group (NCO), and the aldehyde group (CHO).

As a compound having the COOH group (cross-linker), a compound consisting mainly of an aliphatic polycarboxylic acid (including saturated/unsaturated aliphatic series) having a valence number of 2 or more is preferable.

Examples of the saturated aliphatic polycarboxylic acid having a valence number of 2 or more may include citric acid (C6, Valence number: 3), succinic acid (C4, Valence number: 2), adipic acid (C6, Valence number: 2), oxalic acid (C2, Valence number: 2), etc., and examples of the unsaturated aliphatic polycarboxylic acid having a valence number of 2 or more may include maleic acid (C4), fumaric acid (C4), etc.

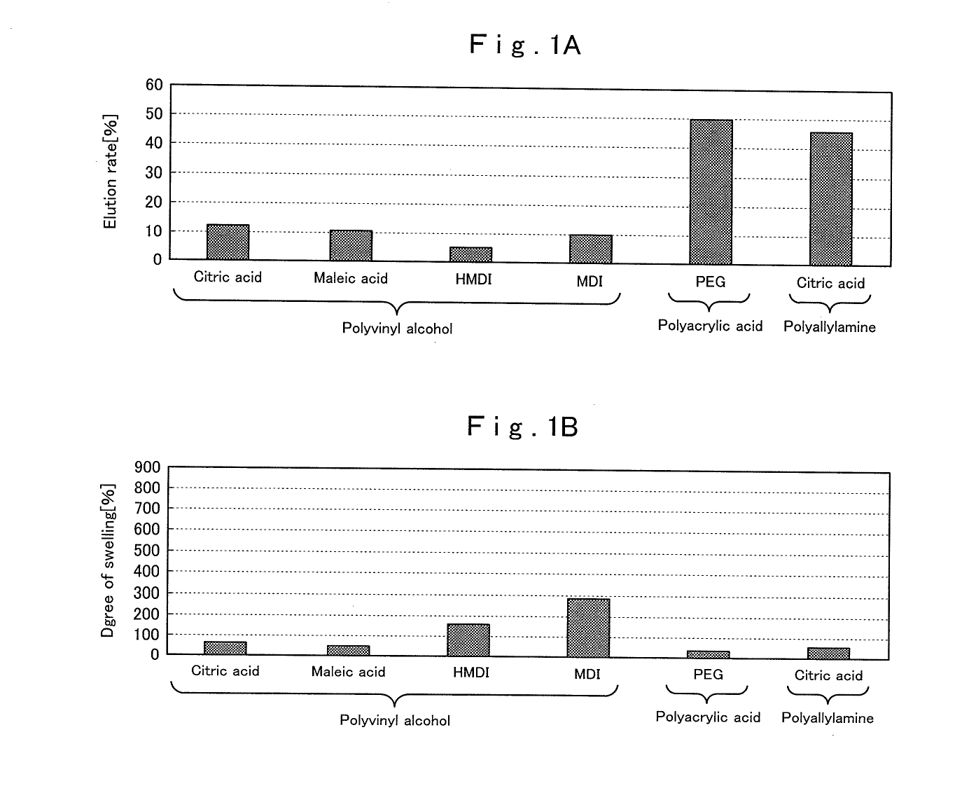

A compound having NCO groups (cross-linker), i.e. polyisocyanate may be an aromatic series such as tolylenediisocyanate (TDI), diphenylmethane4,4′diisocyanate (MDI), metaxylylene diisocyanate (XDI), etc., but a non-aromatic series (aliphatic series, alicyclic series) such as hexamethylene diisocyanate (HMDI), hydrogenerated MDI, hydrogenerated TDI, hydrogenerated XDI, etc., is desirable because it does not have polymeric rigidity unlike the aromatic series and flexibility of the coating film is easily secured. Furthermore, above all, the water-soluble HMDI is preferable in view of preparation of the coating material (see Test 1, FIG. 1).

The compound having the aldehyde group (cross-linker), i.e. cyclic/acyclic aldehyde may include formaldehyde, acetaldehyde, butylaldehyde, valeraldehyde, acrylic aldehyde, benzaldehyde, etc. It should be noted that a modified or polymerized aldehyde is usually used because aldehydes have high reactivity.

Compounding ratios of these cross-linkers slightly vary depending on the molecular weight and valence number (number of the functional groups) of the cross-linker itself, the OH group content (saponification degree in the case of PVAL) and polymerization degree (molecular weight) of the water-soluble resin, as well as the compounding ratio of the plasticizer mentioned below. Typically, the amount of the cross-linker is 5-50 parts, preferably 5-30 parts, more preferably 10-30 parts to 100 parts of water-soluble resin. If the compounding ratio of the cross-linker is excessively low, the required heat and moisture resistance is difficult to provide to the coating film, and if it is excessively high, the coating film is hard and flexibility of the airbag may be impaired.

(2) Furthermore, the water-soluble plasticizer is added to the coating material of the present invention. The plasticizer has the OH group and does not volatilize at a heating treatment temperature of the coating film, i.e. it has a boiling point higher than the heating treatment temperature.

Although the plasticizer may include a plasticizer having one OH group, a plasticizer having a plurality of the OH group or containing mainly of the OH group is used.

Preferably, the plasticizer may include alkylene glycol, polyalkylene glycol, etc., mentioned below. In what follows, “?” means “no data”, and the following figure in parentheses means a carbon number.

Alkylene glycol: ethylene glycol (bp: 197.6° C.) (C2), propylene glycol (bp: 187° C.) (C3), 1,2-butanediol (bp: 193° C.) (C4), 1,3-butanediol (bp: 208° C.) (C4), hexylene glycol (bp: 198° C.) (C6)

Polyalkylene glycol: diethylene glycol (bp; 244° C.), triethylene glycol (bp: 287° C.), PEG200 (bp: 287° C.), PEG300 (bp: ?)

The plasticizer is used as a primary ingredient, and other plasticizers having boiling points near the heating treatment temperature such as ethanolamine (bp: 171° C.) and ethanolacetamide (bp: 160° C.) can also be combined.

A compounding ratio of the plasticizer slightly vanes depending on the OH group content (saponification degree in the case of PVAL) and polymerization degree (molecular weight) of the water-soluble resin, as well as the compounding ratio of the cross-linker.

Typically, the amount of the plasticizer is 25-150 parts, preferably 30-150 parts, more preferably 40-100 parts to 100 parts of the water-soluble resin. If the compounding ratio of the plasticizer is excessively low, the required flexibility (mainly, elongation (E_{B})) is difficult to provide to the coating film, and if it is excessively high, a ratio of the water-soluble resin as a base is relatively low, and a strength required for the coating film is difficult to secure.

The airbag base fabric to which the coating material of the embodiment is applied is a cloth composed of polar synthetic fibers such as a polyamide (PA) fiber yarn and a polyester (PET) fiber yarn.

As the PA fiber, for example, aliphatic polyamides such as nylon 66, nylon 6, nylon 46 and nylon 12; and aromatic polyamides such as aramid or the like are used.

The mode of weaving of cloth is normally plain weaving. However, the mode may be twill weaving or sateen weaving.

Additionally, the cover factor (K) of the cloth represented by the formula (1) is 1200-2400, preferably 1400-2100, more preferably 1600-2000, and most preferably 1800-2000. Light weight and low cost of the airbag are realized by using a cloth having a low cover factor, i.e. high airflow. When the cover factor is excessively low, a predetermined mechanical strength is difficult to obtain for the cloth, and a fusing resin penetrates and flows into textures of the cloth, and the air tightness or flexibility of the airbag base fabric is difficult to secure.

When the yarn density and/or fineness are/is high, the rigidity of the cloth is difficult to easily settle in a predetermined value. Furthermore, when the yarn density is high, the cloth is thick, and problems tend to occur in folding quality/storability of the airbag.

In addition, the coating material is applied on one surface or both surfaces of the cloth.

Herein, if the coating method is suitable for the aqueous coating material based on a water-soluble resin, the method is not particularly limited. For example, in the case of one surface, knife coating (die coating), roller coating (national, reverse), brush coating and spray coating are applied. In the case of both surfaces, immersion (dipping) coating is applied.

The coating amount (converted into solid content) varies depending on the composition of the coating material and properties desired for the base fabric (airflow and flexibility), and the amount is typically 3-50 g/m², preferably 6-30 g/m², more preferably 8-15 g/m². The thickness of the coating film (dry film thickness) is typically 0.1-50 μm, preferably 0.5-20 μm, more preferably 0.5-10 μm.

An excessive amount of coating or an excessive thickness of the coating film are likely to increase the weight or decrease the flexibility of the airbag.

Herein, preferably, the airflow is 20 kPa (Hereinafter, the same shall apply), typically 3.0 L/(cm²·min) or lower, more preferably 1.0 L/(cm²·min), even more preferably 0.1 L/(cm²·min).

After the application, heating treatment is carried out, and the water-soluble resin and the cross-linker are subjected to dehydrocondensation reaction or addition reaction, followed by crosslinking reaction and binding reaction of the cross-linker and the plasticizer. At this time, evaporation of water is enhanced, and solidification of the coating film is also enhanced.

Although the heating means is typically a thermostat bath (hot air), it can be replaced by or combined with other heating means (e.g. microwave, infrared ray, etc.).

In the cross-linked coating film formed in this way, the tensile elongation (E_{B}) (tensile rupture elongation) (ASTM D638, hereinafter, the same shall apply): 50% or more, preferably 100% or more, more preferably 200% or more. When the tensile elongation is excessively low, the flexibility of the airbag base fabric after formation of the dry coating film (coat) is difficult to secure, cracks occur in the elastomer coating film by stress at the time of deploying the airbag, and a predetermined air tightness may be difficult to secure.

The bending resistance of the airbag base fabric related to the invention forming the cross-linked coating film is 55 N or lower, preferably 30 N or lower in bending resistance method B (Circular Bend method) (ASTM-D4032: hereinafter, the same shall apply) in light of the folding quality or the like.

As above, the airbag base fabric which comprises the water-insoluble cross-linked coat (coating film) having excellent heat and moisture resistance (hot water resistance) as well as flexibility on one surface or both surfaces of the cloth can be formed by applying the coating material based on the water-soluble resin of the present invention to the airbag base fabric. Thus, the invention can also be utilized as an airbag base fabric for an airbag installed in a vehicle or the like being used in tropical regions or the like.

### EXAMPLES

Hereinafter, Tests/Examples carried out to support the effect of the present invention will be explained.

As the water-soluble resin, the following was used.

PVAL . . . Saponification degree: 87%, Viscosity (10-12%, 20° C.): 1300-3000 mPa·s

Polyacrylic acid . . . Mw: 2500

Polyallylamine . . . “IIA-25” (product ID number) produced by Ditto Boseki Co., Ltd., 10% aqueous solution

<Test 1>

An aqueous coating material was prepared by adding 50 parts of each cross-linker to 100 parts of a water-soluble resin (solid content) in each water-soluble resin aqueous solution. Subsequently, each aqueous coating material was applied on a glass plate, which was then heat-treated in a condition of 170° C.×330 s (5.5 min.), and a film-shaped coating film (100 μm) was peeled from the glass plate to prepare a rectangular test specimen (50 mm×50 mm).

Each test specimen was measured for the elution rate and the degree of swelling after hot-water immersion (80° C.×30 min.) according to JIS K 7209.

From FIGS. 1(A) and (B) showing these results, it could be confirmed that combinations of PVAL with citric acid, maleic acid, HMDI or MDI were preferable in light of the heat and moisture resistance (hot water resistance). Other combinations indicated that the required heat and moisture resistance (hot water resistance) mentioned below i.e. the above-mentioned elution rate after hot-water immersion: 20% or lower and the degree of swelling of 400% or lower were difficult to obtain.

Additionally, in these combinations, the cases of combinations of PVAL with citric acid or maleic acid showed the degree of swelling of 100% or lower, suggesting that they are more preferable.

<Test 2>

From the above test results, the combination of PVAL with citric acid was selected, aqueous coating materials having different compounding ratios of citric acid were prepared, and the same test was carried out.

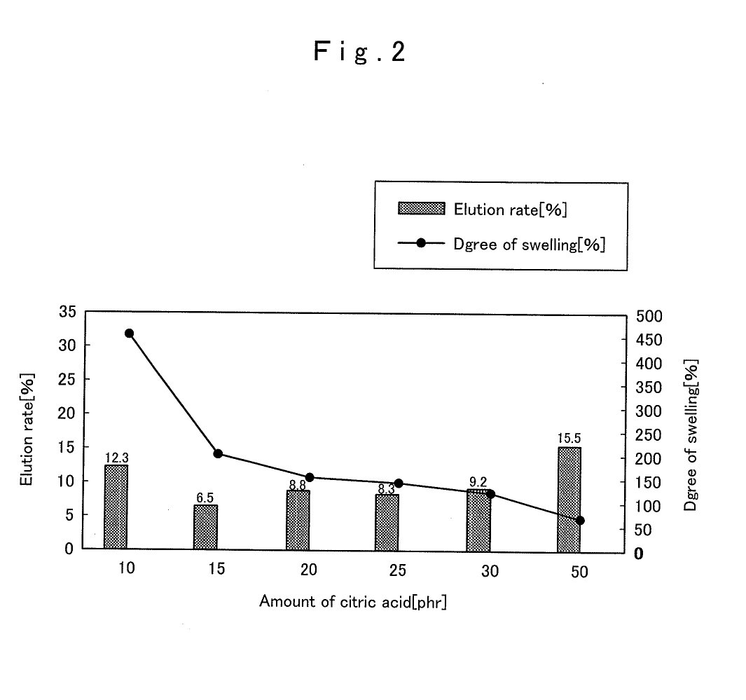

From FIG. 2 showing these results, it could be confirmed that 12 parts or more of compounding ratio of citric acid to 100 parts of PVAL could generate more preferable heat and moisture resistance. In addition, the upper limit compounding ratio of citric acid to 100 parts of PVAL is preferably 40 parts, and if the amount is over this ratio, the elution rate of citric acid is increased in vain and may have negative effects on the fiber constituting the airbag (e.g. the case of polyimide).

<Test 3>

In combinations having different compounding ratios of citric acid to 100 parts of the PVAL, 80 parts of the plasticizer (PEG200) was further added, for which the same test as Test 2 (only for degree of swelling) was carried out.

The results are shown in FIG. 5. Also in the combinations to which the plasticizer was added, it could be confirmed that 17 parts or more of compounding ratio of citric acid to 100 parts of PVAL could generate more preferable heat and moisture resistance.

At the same time, each test specimen mentioned above was measured for tensile elongation (E_{B}) according to ASTM D638.

As a result, it could be confirmed that more preferable flexibility (elongation) with elongation (E_{B}): 200% or higher could be obtained in all test specimens.

<Applications>

1) Four kinds of coating materials (aqueous solution) for the airbag base fabric having the following compositions were prepared.

PVAL (Polymerization degree 1800, saponification degree: 87-89%): 100 parts PEG300: 20, 30, 60 or 80 parts

Citric acid: 20 parts

Water: 800 parts

2) The aqueous solution which was slightly heated (30° C.) was applied, by immersion coating, on a PET base fabric (Plain weaving: 560 dtex, Picks: 46 pieces, Cover factor: 2065) unreeled from an unreeling roller (Coating amount of the solid content: 10 μm², Thickness of the coating film: about 3 μm).

3) The PET base fabric coated by immersion is introduced into a thermostat chamber, heated by hot air in a condition of 170° C.×330 s, and reeled by a reeling roper.

The coated PET base fabric prepared in this way, which comprises the cross-linked coating film on both surfaces (airbag base fabric) was measured for bending resistance by the bending resistance method B.

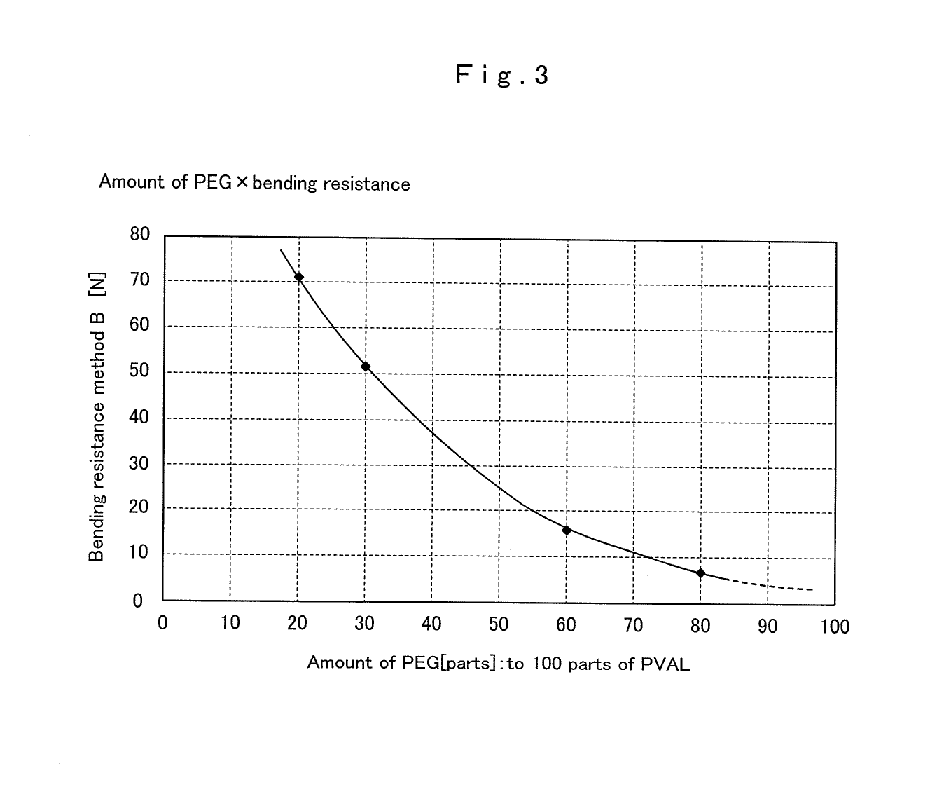

From FIG. 3 showing these measured results, it could be confirmed that the composition of the coating material comprising about 25 parts or more, more preferably about 45 parts or more of PEG to 100 parts of PVAL was preferable in order to obtain a bending resistance suitable for the airbag base fabric (in bending resistance method B) of 55 N or lower, more preferably 30 N or lower. It should be noted that the PET cloth before coating showed the value of 3.9 N in the bending resistance method B.

In addition, all coated PET base fabrics showed airflows (at 20 kPa or lower) of 0.0 L/(cm²·min).

(B) Coating Material of the Second Embodiment:

The coating material of the present embodiment is an invention related to a coating material focused on fogging resistance in summer or tropical regions and heat aging resistance in a case where PVAL was used as the water-soluble resin, citric acid was used as the cross-linker, a liquid polyalkylene glycol was used as the plasticizer in the coating material of the first embodiment. In the following description, “phr” means “parts per hundred parts of resin.”

That is, the coating material for the airbag base fabric which comprises PVAL together with citric acid, liquid PEG and liquid polyalkylene glycol (liquid PAG) having a molecular weight of 1000 or more is characterized in that the plasticizer consists mainly of the liquid PEG, to which a coatable amount of the liquid PAG is added, and in relation to the fogging resistance, a haze (JIS K 7105) is 10.0 or lower.

It should be noted that liquid PEG having a molecular weight of 1000 or more does not exist. Hereinafter, liquid PAG means a PAG having a molecular weight of 1000 or more unless otherwise noted.

In the constitution mentioned above, a compounding ratio of citric acid is preferably an amount which can prevent progression of post-crosslinking and maintain elongation (E_{B}) (ASTM D 638) of 150% or higher, more preferably 200% or higher in heat aging test (120° C.×400 h).

When the constitution mentioned above is rewritten with the addition of compounding ratios, the constitution is as below.

The coating material for the airbag base fabric which comprises PVAL together with citric acid, liquid PEG and liquid PAG is characterized in that citric acid: 1-10 parts (preferably 3-5 parts), liquid PEG: 25-75 parts, liquid PAG: 10-30 parts are compounded to PVAL: 100 parts, and the amount of liquid PAG is below twice as much as liquid PEG (preferably equal quantity, more preferably half quantity).

In the above description, liquid PEG is preferably selected from PEGs having a mean molecular weight (M_{w}): 250-550 in light of the fogging resistance and flexibility at low temperature. When the M_{w} is low, it is likely to volatilize, and when the M_{w} is high, the freezing point is around normal temperature, and the flexibility at low temperatures is difficult to secure.

As the liquid PAG having a molecular weight of 1000 or more, a copolymer of ethylene oxide and propylene oxide is preferable because a PAG which is liquid at normal temperature while having a molecular weight of 1000 or more can be easily obtained. In light of compatibility with PVAL, it is preferable that the compounding ratio is selected from a range of M_{w}: 1500-4500 (preferably 2000-4000) and is below twice as much as liquid PEG (preferably half again or less, more preferably half quantity or less). It was confirmed that a homogenous coating film was difficult to obtain by liquid PAG alone.

Additionally, a liquid PAG having no compatibility with PVAL can become compatible with PVAL by combining a liquid PAG having a high molecular weight (1000 or more) with a liquid PEG.

Compounding of liquid PAG contributes to inhibition of thermal deterioration/degradation of PVAL.

Incidentally, in formulation of citric acid: 4 phr, each Haze value of 1) PEG300: 80 phr, 2) PEG300: 60 phr, and 3) PEG300: 60 phr+ liquid PAG (EO/PO copolymer (MW 3300)): 16 phr is 6.6, 1,8 and 2.3 respectively, suggesting that fogging resistance can be improved by adding the liquid PAG having a molecular weight of 1000 or more. That is, the total amount 76 phr of PEG and PAG in 3) is close to PEG: 80 phr in 1), however, its Haze value (JIS K 7105) is less than half the value in 1).

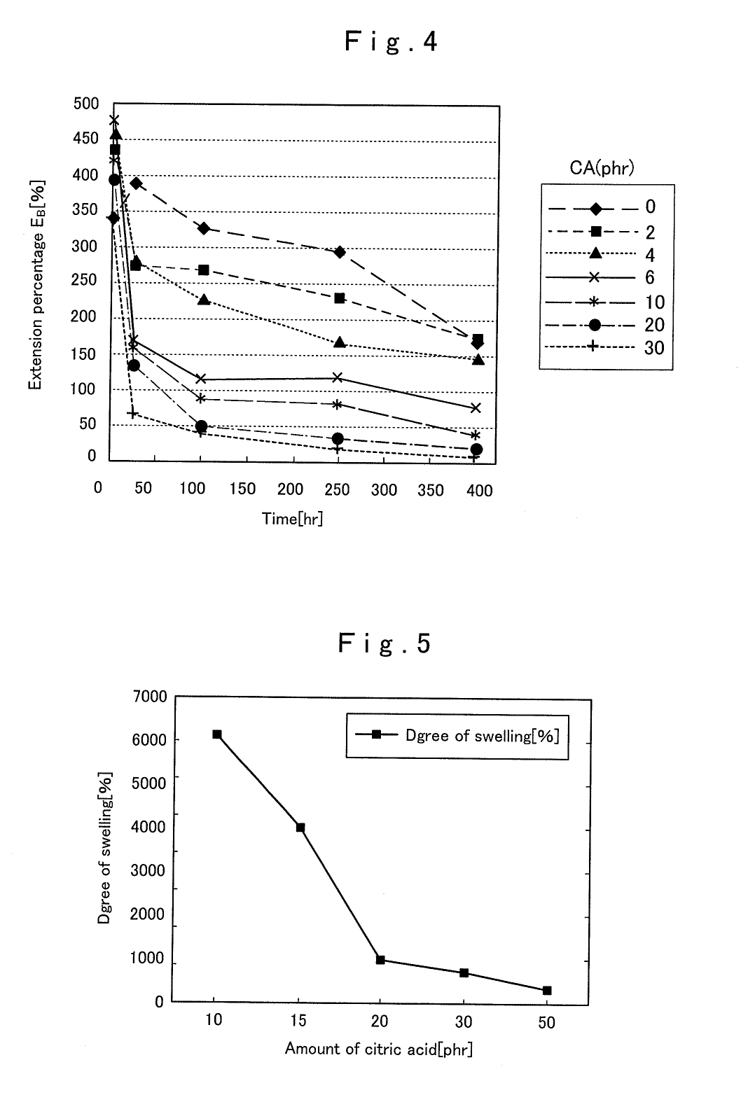

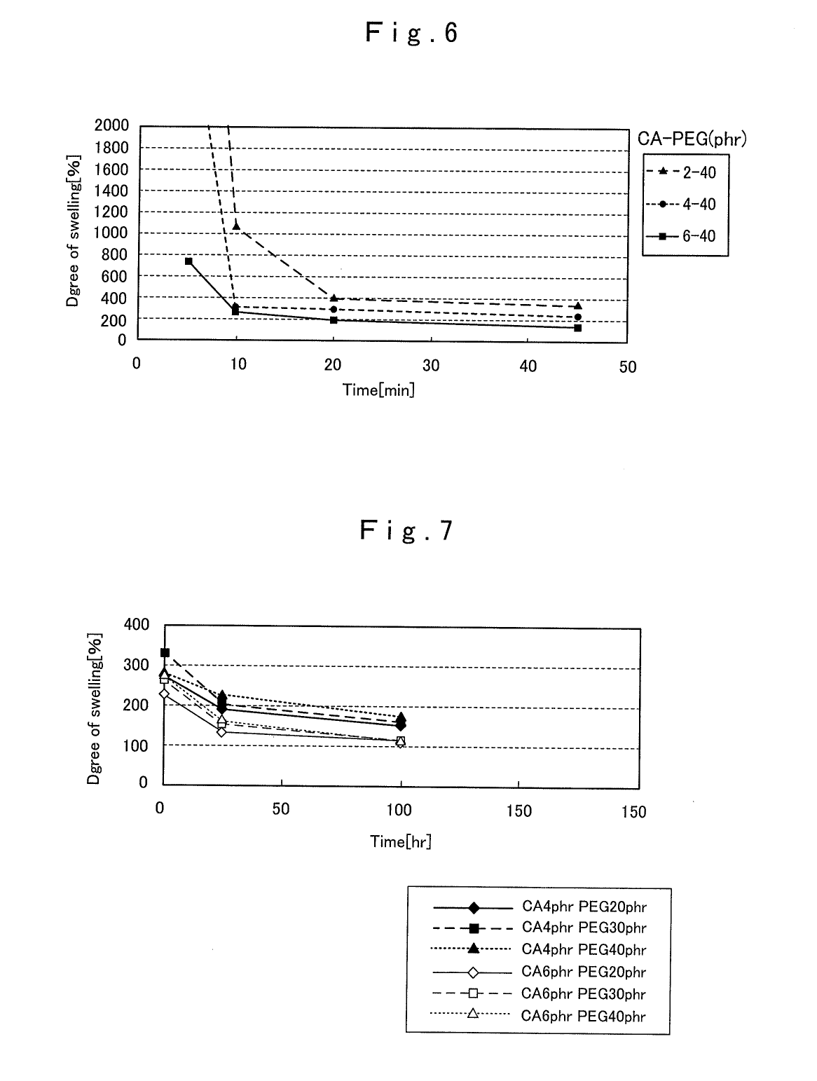

As measures to improve heat resistance (particularly heat aging resistance), the inventors found that when the compounding ratio of citric acid was relatively lowered compared to that in the first embodiment, the heat aging resistance could be improved (see FIG. 4).

That is, it was found that E_{B}: 150% or higher could be secured 250 h after the heat aging test (public test method: 120° C.). Furthermore, it was found that when the ratio of citric acid was 1-5 phr, E_{B}: 100% or higher could be secured even 400 h after the heat aging test (public test method: 120° C.).

If the coating film is exposed to a highly-heated atmosphere for an extended period of time, enhanced post-crosslinking leads to high cross-link density of the coating film, resulting in decreases in E_{B} and degree of swelling.

However, when the compounding ratio of citric acid is too low, it takes a lot of time to complete cross-linking, thus 3 phr or more is preferable in light of productivity.

In addition, as shown in FIG. 7, in a case of 6 phr of citric acid, the degree of swelling after heat aging test is likely to be lowered (inclined to be excessively cross-linked).

The aforementioned results indicate that the compounding ratio of citric acid is preferably 3-5 phr in a range of PEG:20-60 phr.

In addition, the boiling point of PEG is at least 244° C. of diethylene glycol, and it scarcely volatilizes at a temperature in a usual atmosphere where the airbag is used.

Furthermore, flexibility after heat aging test by the amounts of PEG was evaluated according to the bending resistance method B. Table 1 showing the results indicates that the compounding ratios of PEG can hardly affect flexibility.

TABLE 1

| | PEG (phr) | | |
|---|---|---|---|
| | 20 | 40 | 60 |
| Bending resistance method B | 12.60 | 15.50 | 14.12 |

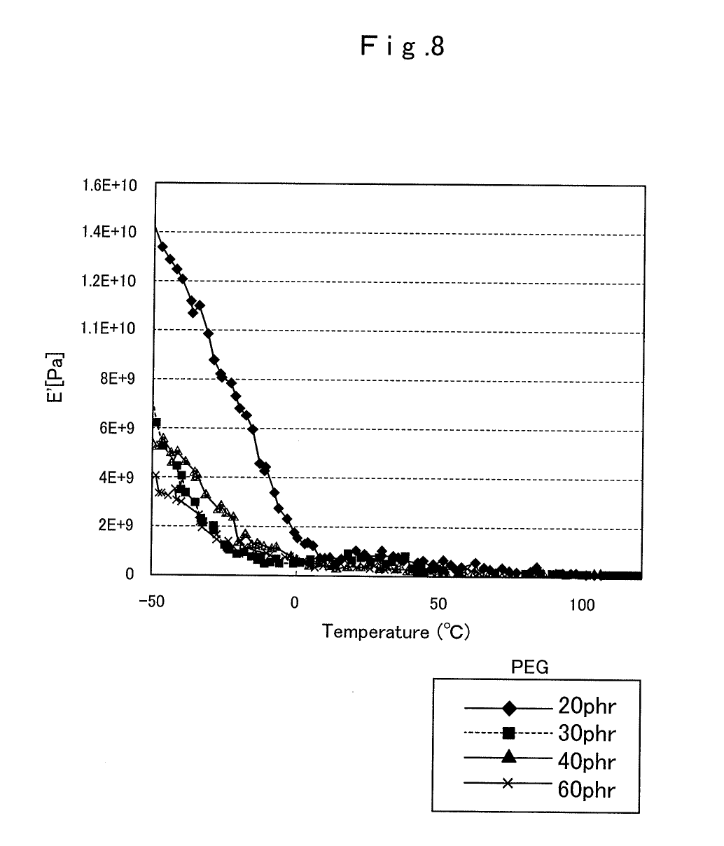

In addition, the ratio of PEG300 was changed within the range of 20-60 phr, and a dynamic viscoelasticity (JIS K 7918) was measured to evaluate low-temperature properties. FIG. 8 showing the results indicates that elasticity E′ is significantly changed between PEG: 20 phr and 30 phr. Consequently, the lower limit of the amount of PEG is preferably 25 phr, more preferably 30 phr in light of low-temperature resistance, and the upper limit is preferably 70 phr, more preferably 60 phr in light of fogging resistance.

Preferably, sub materials as mentioned below are added, at each compounding ratio, to the coating material for the airbag base fabric of the present invention in light of further comprehensive improvement of coating properties (The same shall apply to the coating material of the first embodiment.)

1) Age resistor (antioxidant): Although not limited to, among amines such as N,N′-di-2-naphthyl-P-phenylenediamine, quinones such as 2,5-di-(t-amyl) hydroquinone and phenols such as 2,6-di-t-butyl-p-cresol, heat-resistant compounds can be preferably used. Although the compounding ratio of the age resistor varies depending on its kind and required characteristics, it is typically selected from the range of 0.2-1 phr quantum vis.

2) Rust inhibitor: Although not limited to, sodium citrate, sodium sebacate, sodium molybdate, sodium benzoate, sodium nitrite, etc., can be preferably used. Although the compounding ratio of the rust inhibitor varies depending on its kinds and required rust resistance, it is selected from the range of 0.01-1 phr quantum vis.

3) Flame retardant: Phosphates (TCP, TPP, TXP, etc.), guanidine phosphate, ammonium phosphate, guanidine sulfate, antimony trioxide, titanium oxide, melamine, aluminum hydroxide, chlorinated paraffin, etc., can be preferably used. Although the compounding ratio of the flame retardant varies depending on its kind and required characteristics, it is selected from the range of 1-10 phr quantum vis.

Like the coating material of the first embodiment, the coating material of the present embodiment is also applied on one surface or both surfaces of the base fabric (cloth), and heated to manufacture the airbag base fabric comprising a cross-linked coating film. In that case, the kind of the base fabric to be used, the coating method, the heating conditions, furthermore, the characteristics of the cross-linked coating film and the characteristics of the airbag base fabric are the same as those in the first embodiment. Thus, their explanations are omitted.

(C) Airbag Base Fabric

Next, an airbag base fabric which is easy to crease during folding in housing in a vehicle and can reduce restoration eliminating the folding lines after folding will be explained.

In the airbag base fabric of the embodiment, a coating film is formed by applying a coating material on a surface of a cloth (base fabric) composed of a polyester fiber.

As the polyester fiber constituting the cloth, a PET (polyethylene terephthalate) fiber, a PBT (polybutylene terephthalate) fiber or the like can be used. Preferably, the PET fiber is used in light of versatility and cost reduction.

As the polyester fiber constituting the cloth, a fiber having a Young's modulus of 10-25 GPa (preferably, 10-22 GPa) is used. When Young's modulus is lower than 10 GPa, the cloth is too soft, and the cloth is difficult to crease in folding the airbag. In contrast, when Young's modulus is higher than 25 GPa, the cloth is too hard, and the folding lines are likely to be eliminated by spring back.

For the cloth, the cover factor (K) represented by the formula (1) is set within the range of 1000-2700 (preferably 1200-2400, more preferably 1400-2200, even more preferably 1600-2100, most preferably 1800-2100). Low cover factor (K) means that warp/weft density and/or warp/weft fineness are relatively low. On the other hand, high cover factor (K) means that warp/weft density and/or warp/weft fineness are relatively high.

When the cover factor (K) is lower than 1000, the mechanical strength (tensile strength, etc.) required for the airbag is difficult to obtain, and air tightness and flexibility of the airbag base fabric are difficult to secure due to ingression of the molten coating material between folding lines. On the other hand, when the cover factor (K) is higher than 2700, the rigidity of the cloth is high, and flexibility required for the airbag is difficult to obtain, and also problems tend to occur in folding workability and storability when the airbag made of the airbag base fabric is mounted in a vehicle.

As the coating material to be used in the present invention, the coating materials explained in the first and second embodiments can be preferably used.

The thickness of the coating film formed by the coating material is 0.1-50 μm (preferably 0.5-20 μm, more preferably 0.5-10 μm). Excessive thickness of the coating film is likely to increase the weight of the airbag and decrease the flexibility of the base fabric.

For the coating film, the tensile elongation (E_{B}) (tensile rupture elongation) (ASTM D638) is 50% or higher (preferably 100% or higher, more preferably 200% or higher). When the tensile elongation is lower than 50%, the flexibility is difficult to secure for the airbag base fabric, and cracks occur in the coating film by stress at the time of deployment of the airbag, thus a predetermined air tightness is difficult to secure.

In addition, Young's modulus of the coating film is lowered to less than that of the cloth, and it is set within the range of preferably 5-300 MPa, more preferably 5-200 MPa, even more preferably 10-100 MPa. When Young's modulus is too low, the base fabric is difficult to crease in folding the airbag due to softness of the coating film. On the other hand, when Young's modulus is too high, force of the spring back is increased due to hardness of the coating film, the folding lines are eliminated, and the folded shape is difficult to maintain.

For the airbag base fabric of the embodiment constructed by forming the coating film on the surface of the cloth as mentioned above, the airflow at 20 KPa is preferably set to 0.3 L/(min·cm²) or lower, more preferably 0.1 L/(min·cm²) or lower. When the airflow is too high, gas for inflating passes through the base fabric after completion of inflating of the airbag, and internal pressure at the time of the completion or the inflating is difficult to maintain for a predetermined time.

In addition, for the airbag base fabric of the embodiment, the bending resistance is preferably set to 55 N or lower, more preferably 30 N or lower in bending resistance method B (Circular Bend method) (ASTM-D4032). When the bending resistance is high, the folded shape is difficult to maintain.

Hereinafter, a test for evaluating the folded shape-maintaining property of the airbag base fabric (spring back test) will be explained.

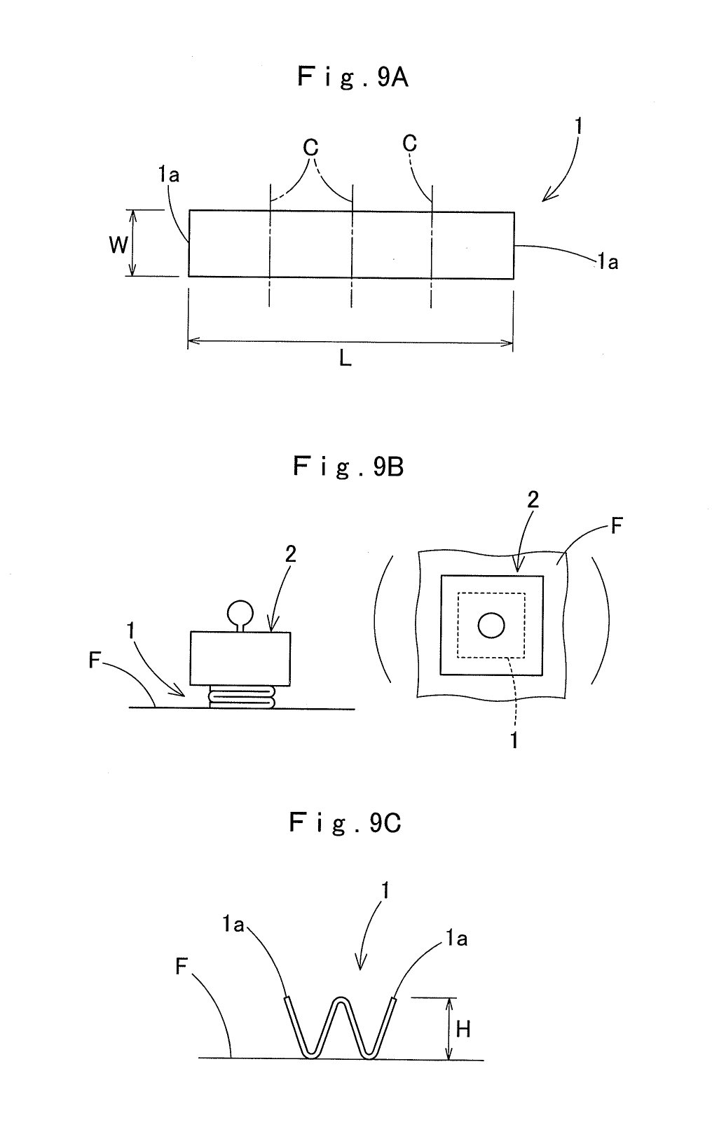

The method of the spring back test is as shown in FIG. 9.

1) From each airbag base fabric, a band-like test specimen 1 of width W: 30 mm×length L: 150 mm is prepared so that its longitudinal direction is parallel to the warp or the weft.

2) The test specimen 1 is given three folding lines C along a margin of its short direction, and folded up four times while the width of the longitudinal side is shortened as shown in FIG. 9A.

3) The test specimen 1 folded in this way is laid on a horizontal plane F, and a weight 2 is put on the test specimen 1 and pushed for 60 seconds as shown in FIG. 9B. The weight is 3000 g and has a 50-square mm bottom surface.

4) Subsequently, as shown in FIG. 9C, the test specimen 1 is laid on the horizontal plane F with both ends 1a of the longitudinal direction upward and left for 2 minutes, and, in this state, the height H of the nearly accordion-shaped (nearly W-shaped) test specimen is measured. It should be noted that, in the embodiment, this test is carried out under a condition of temperature: 25° C. and humidity: 50%.

In this test, each test specimen composed of four airbag base fabrics of the Example, Comparative Example, Reference Example 1 and Reference Example 2 described below was tested. It should be noted that the cover factor is calculated in a condition of 1 dtex=0.9 denier.

### Example 1

Cloth: PET fiber cloth

wherein a weaving yarn composed of a PET fiber yarn doubling of a Young's modulus=11.8 GPa and 560 dtex is woven by plain weaving (warp; 46/in, weft 46/in), with a cover factor (K)=2065,

Coating material: which is composed as mentioned below and has a Young's modulus of the coating film of 30 MPa,

PVAL (Polymerization: 1800, Saponification degree: 87-89%): 100 parts

Citric acid: 20 parts

PEG300: 80 parts

Water: 800 parts

A base fabric was prepared by applying the coating material on both surfaces of the cloth so that the thickness of each coating film was 2 μm (after heat treatment). The airflow of the base fabric was 0.04 L/(min·cm²).

### Comparative Example

Cloth: The same cloth as in Example 1.

Coating material: None

The airflow of the cloth was 4.7 L/(min·cm²).

### Reference Example 1

Cloth: Nylon 66

wherein a weaving yarn composed of a Nylon 66 fiber yarn doubling of a Young's modulus=8.1 GPa and 470 dtex is woven by plain weaving (warp: 46/in, weft: 46/in), with a cover factor (K)=1892,

Coating material: None

The airflow of the cloth was 4.9 L/(min·cm²).

### Reference Example 2

Cloth: The same cloth as in Reference Example 1.

Coating material: An emulsion coating material composed of a silicone elastomer resin of which Young's modulus is 2 MPa at the time of formation of the coating film

A base fabric was prepared by applying the coating material on both surfaces of the cloth so that the thickness of each coating film was 15 μm. The airflow of the base fabric was 0.0 L/(min·cm²).

While the height H of the test specimen was 19 mm in the Example, it was 7 mm in the Comparative Example. In addition, the heights H of Reference Examples 1 and 2 were 20 mm and 10 mm respectively.

For the base fabric of the present invention, the height H of the test specimen in the spring back test is preferably within the range of 15-35 mm, more preferably 16-30 mm, even more preferably 18-25 mm.

The lower height H of the test specimen means a great force of spring back (elastic restoring force) of the base fabric. Thereby, problems tend to occur in folding workability of the airbag. That is, folding lines are difficult to make in folding the airbag, and the folded shape is difficult to maintain without external force.

On the other hand, the higher height H of the test specimen means a small force of spring back (elastic restoring force) of the base fabric and high rigidity. For example, an airbag folded using a base fabric in which the height of the test specimen close to a folding pitch 37.5 mm (150 mm/4) is maintained has little flexibility. Thus, there is a problem that housing workability of the airbag folded so as to be laminated is poor.

As shown in Comparative Example, since a polyester fiber cloth has a high Young's modulus and high rigidity, even if it can be once folded in a non-coating condition without a coating material, the force of the spring back which undoes the folding is high. Thus, its folded state is difficult to maintain compared to the base fabric in Reference Example 1 using nylon 66 with a lower Young's modulus than of PET fiber.

As shown in Example mentioned above, both in a case of use of the PET fiber cloth and a case of use of a cloth having a high cover factor, it could be confirmed that when a coating film having a lower Young's modulus than that of the cloth was formed, a base fabric of which the test specimen height H was within the predetermined range (the range in the present invention) was obtained.

Reference Example 2 shows a case that, on the cloth used in Reference Example 1, a coating film having a lower Young's modulus than that of the fiber constituting this cloth is formed. In such a base fabric, since the rigidity of the coating film is low, the rigidity of the base fabric is too low. Thus, folding lines are difficult to make in folding, and when the base fabric is used as an airbag, it is difficult to fold so as to be laminated. Consequently, the folding is likely to be disrupted, the folding state is difficult to maintain, and problems occur in housing workability of the airbag.

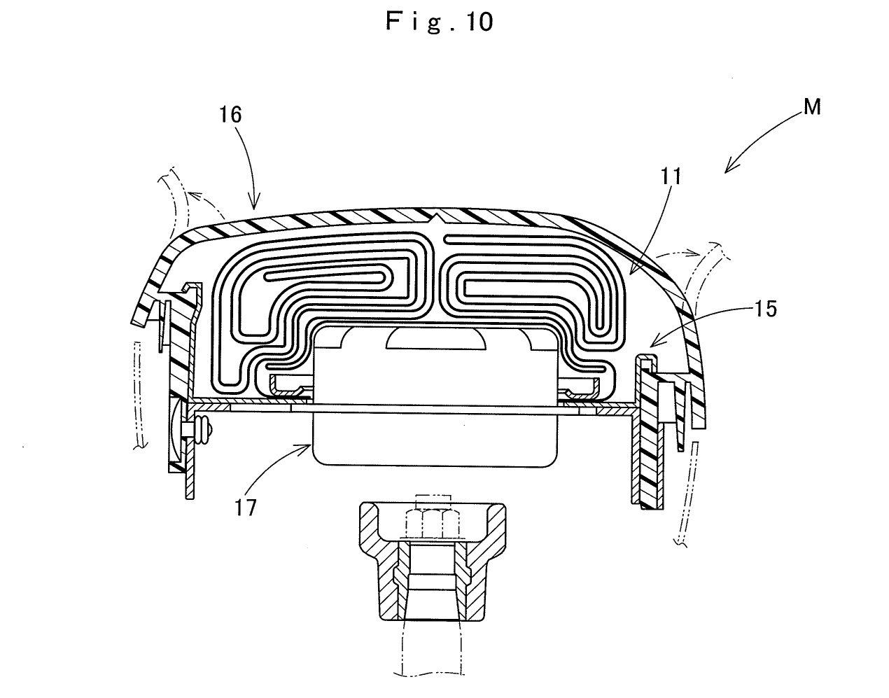

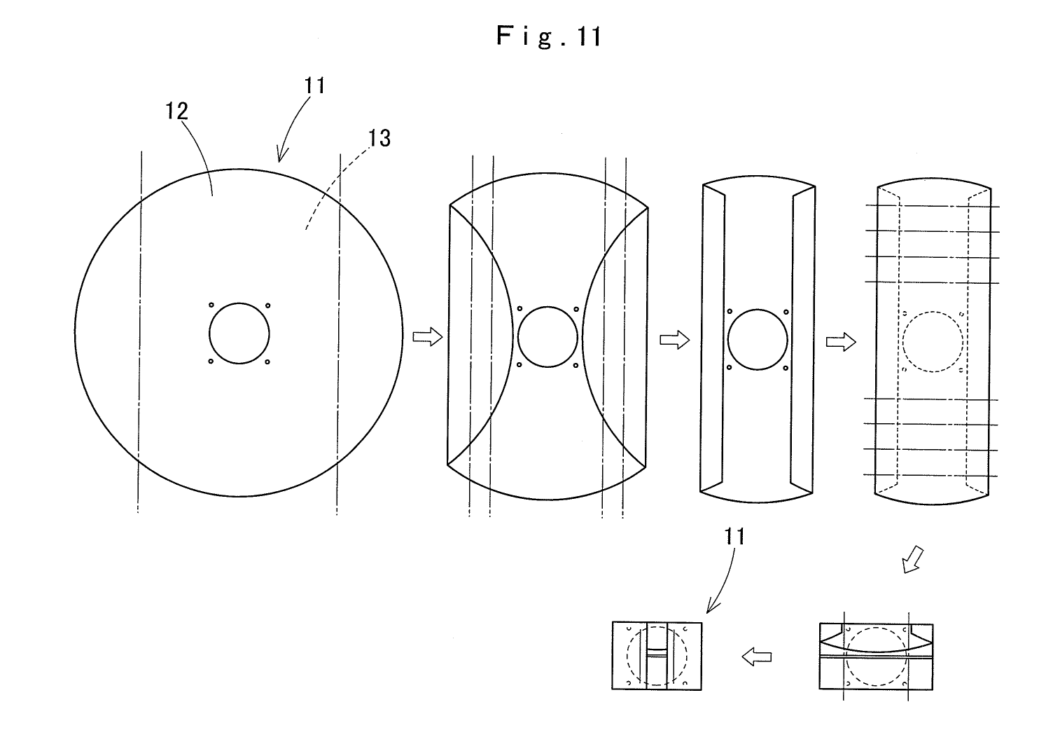

The base fabric of Examples is folded as shown in FIG. 11 and used as an airbag 11 of an airbag device M for a steering wheel shown in FIG. 10.

Two base fabrics (base fabric on the car body side 12, base fabric on the occupant side 13) which was flatly deployed, stitched at their peripheries and put together were folded so as to be laminated, through folding for crosswise reduction to shorten the width of the crosswise direction and folding for anteroposterior reduction to shorten the width of the anteroposterior direction. Thus, even when the airbag 11 is folded, it can be folded with good workability, and the folded shape can be maintained without external force. In addition, the folded base fabrics (base fabric on the car body side 12, base fabric on the occupant side 13) have appropriate flexibility. Thereby, when the airbag is mounted in a vehicle, it can be smoothly housed so as to be further folded in a narrow gap between an airbag cover 16 and an inflator 17 in a case 15, as shown in FIG. 10.

### EXPLANATION OF SYMBOLS

1: Test specimen
2: Weight
F: Horizontal plane
H: Height of the test specimen

1. An aqueous coating material based on a water-soluble resin for an airbag base fabric, wherein
the water-soluble resin is polyvinyl alcohol (PVAL), and
an aliphatic polycarboxylic acid or polyisocyanate which can react with the OH group of the PVAL as a cross-linker, and a liquid polyol as a plasticizer are added.

2. The coating material for the airbag base fabric according to claim 1, wherein
the PVAL has a saponification degree of 70 mol % or higher and a polymerization degree of 1000-4000,
the aliphatic polycarboxylic acid has 2-6 carbon atoms, and
the liquid polyol is alkylene glycol (2-6 carbon atoms) or polyalkylene glycol (2 or 3 monomeric carbon atoms).

3. The coating material for the airbag base fabric according to claim 1, wherein
the PVAL has a saponification degree of 80-95 mol % or higher and a polymerization degree of 1500-3800,
the aliphatic polycarboxylic acid is citric acid or maleic acid,
the polyisocyanate is hexamethylene diisocyanate or diphenylmethane 4,4′diisocyanate,
the liquid polyol is an alkylene glycol selected from ethylene glycol or propylene glycol, and/or a liquid polyalkylene glycol.

4. A coating material for the airbag base fabric which comprises PVAL together with citric acid, liquid polyethylene glycol (liquid PEG), wherein
1-50 parts mass of the citric acid and 25-150 parts mass of the liquid PEG are compounded to 100 parts mass of the PVAL.

5. A coating material for the airbag base fabric which comprises PVAL together with citric acid, liquid PEG and liquid polyalkylene glycol (liquid PAG) having a molecular weight of 1000 or more, wherein
1-10 parts mass of the citric acid, 25-75 parts mass of the liquid PEG and 10-30 parts mass of the liquid PAG are compounded to 100 parts mass of the PVAL, and the compounding ratio of the liquid PAG is below twice as much as the liquid PEG.

6. An aqueous coating material based on the water-soluble resin for the airbag base fabric, wherein
the water-soluble resin comprises the OH group as a water-solubilizing group, and
an organic cross-linker which has a functional group (reactive group) which can form a cross-linked coating film by reacting with the OH group and can provide a required heat and moisture resistance to the cross-linked coating film, and a plasticizer having a plurality of the OH group are added.

7. An airbag base fabric which comprises a water-insoluble cross-linked coating film (coating film) formed by the coating material for the airbag base fabric described in claim 1 on one surface or both surfaces of a cloth woven with a polar synthetic fiber.

8. The airbag base fabric according to claim 7, wherein
the bending resistance of the airbag base fabric comprising the cross-linked coating film is 55 N or lower in bending resistance method B (ASTM-D4032).

9. A manufacturing method of the airbag base fabric, wherein the coating material for the airbag base fabric described in claim 1 is applied on one surface or both surfaces of a cloth woven with a polar synthetic fiber, and a water-insoluble cross-linked coating film is formed by heat treatment.

10. A manufacturing method of the airbag base fabric, wherein the coating material for the airbag base fabric described in claim 1 is applied on one surface or both surfaces of a cloth composed of a polar synthetic fiber so that its application quantity (dry) is 3-50 g/m².

11. The airbag base fabric constructed by forming a coating film with a coating material on a surface of a cloth composed of a textile, wherein
it comprises the cloth made of a polyester fiber and having a cover factor (K)=NW×DW^{0.5}+NF×DF^{0.5} (wherein NW: warp density (thread/in), DW: warp fineness (denier), NF: weft density (thread/in), DF: weft fineness (denier)) set within the range of 1000-2700 and the coating film having a Young's modulus set to be smaller than that of the cloth, and
the airbag base fabric shows an airflow of 0.3 L/(min·cm²) or less at 20 KPa, and a height of a test specimen after <Spring back test> on the following conditions ranges within 15-35 mm:
<Spring back test>
1) a band-like test specimen of 150 mm×30 mm is prepared by cutting from the airbag base fabric so that a longitudinal direction is parallel to the warp or the weft;
2) the test specimen is folded up four times while the width of the longitudinal side is shortened;
3) the folded test specimen is laid on a horizontal plane, on which a 3000 g weight having a 50-square mm bottom surface is put and pushed for 60 seconds; and
4) the test specimen after the weight being removed is left on the horizontal plane with both ends of the longitudinal direction upward for 2 minutes, and then a height of the test specimen is measured.

12. The airbag base fabric according to claim 11, wherein a Young's modulus (JIS L 1013) of the coating film is set within the range of 5-300 MPa.

13. The airbag base fabric according to claim 11, wherein a thickness of the coating film is set within a range of 0.1-50 μm.

14. The airbag base fabric according to claim 11, wherein the coating material comprises:
polyvinyl alcohol (PVAL), and
an aliphatic polycarboxylic acid or polyisocyanate which can react with the OH group of the PVAL as a cross-linker, and a liquid polyol as a plasticizer are added.

15. An airbag base fabric which comprises a water-insoluble cross-linked coating film (coating film) formed by the coating material for the airbag base fabric described in claim 4 on one surface or both surfaces of a cloth woven with a polar synthetic fiber.

16. An airbag base fabric which comprises a water-insoluble cross-linked coating film (coating film) formed by the coating material for the airbag base fabric described in claim 5 on one surface or both surfaces of a cloth woven with a polar synthetic fiber.

17. A manufacturing method of the airbag base fabric, wherein the coating material for the airbag base fabric described in claim 4 is applied on one surface or both surfaces of a cloth woven with a polar synthetic fiber, and a water-insoluble cross-linked coating film is formed by heat treatment.

18. A manufacturing method of the airbag base fabric, wherein the coating material for the airbag base fabric described in claim 5 is applied on one surface or both surfaces of a cloth woven with a polar synthetic fiber, and a water-insoluble cross-linked coating film is formed by heat treatment.

19. A manufacturing method of the airbag base fabric, wherein the coating material for the airbag base fabric described in claim 4 is applied on one surface or both surfaces of a cloth composed of a polar synthetic fiber so that its application quantity (dry) is 3-50 g/m².

20. A manufacturing method of the airbag base fabric, wherein the coating material for the airbag base fabric described in claim 5 is applied on one surface or both surfaces of a cloth composed of a polar synthetic fiber so that its application quantity (dry) is 3-50 g/m².
